(19) United States
(12) Patent Application Publication
(10) Pub. No.: US 2012/0230613 A1
(43) Pub. Date: Sep. 13, 2012

(54) Self-closing Device for a Flexible Pouch

(76) Inventors: Roderick E. Galland, Lead, SD (US); Hossein Monajjem, Fort Collins, CO (US)

(21) Appl. No.: 13/460,510

(22) Filed: Apr. 30, 2012

Related U.S. Application Data
(63) Continuation of application No. 13/047,661, filed on Mar. 14, 2011.
Application No. 13/047,661 is a continuation of application No. 11/810,328, filed on Jun. 4, 2007, now abandoned.
(60) Provisional application No. 60/810,535, filed on Jun. 2, 2006.

(51) Int. Cl. B65D 33/24; B29C 47/00; B29C 45/00

(52) U.S. Cl. 383/43; 29/896.9

(57) ABSTRACT

A squeeze-openable device applied near the opening of a sleeve-like bag snaps back upon its release to close the bag and prevent the bag's contents from spilling. The device has opposing strips connected to one another at each end. Each strip has a structure that assists the strips in snapping back to its original position to close the bag. The device can be placed on the outside of the bag or within the bag's throat. The device can have a latch to secure one strip to the other.

### CROSS-REFERENCE TO RELATED APPLICATIONS

This application is a continuation of co-pending application Ser. No. 13/047,661, filed Mar. 14, 2011, which is a continuation of application Ser. No. 11/810,328, filed Jun. 4, 2007, now abandoned, and also claims the benefits of U.S. Provisional Application No. 60/810,535, filed Jun. 2, 2006, the disclosure of which is hereby incorporated by reference in its entirety including all figures, tables and drawings.

### BACKGROUND OF THE INVENTION

The convenience of disposable packaging has become increasingly popular in our busy society. Everything from produce, to food staples, to snack foods is now packaged in flexible pouches. These bags or pouches however usually have no support and collapse once opened. The mouth or opening of the bag likewise collapses on itself to either obstruct access to the bag or to allow the contents of the bag to flow freely out of the bag. A self-expanding and reclosable bag is described in U.S. Pat. No. 5,174,658. This bag is provided with extensible stays to assure that once opened, the throat of the bag remains open and its contents accessible. In certain situations however it is preferred that the throat or opening of the bag close immediately after access to prevent its contents from spilling. For example, while consuming a sleeve of sunflower seeds on a car trip, it would be preferred that an open bag close automatically when placed on the next seat to prevent the seeds from spilling all over the car. It would also be convenient if once closed, the bag could be reopened by simply squeezing it with one hand.

There is a need for a squeeze-openable device applied to a flexible bag that recloses that bag upon release to prevent the bag's contents from spilling. Such a bag would be particularly useful for items such as, for example, ready-to-go snack foods, confectionary packaging, medical and pharmaceutical packaging, and precision parts packaging.

All patents, patent applications, provisional patent applications and publications referred to or cited herein, are incorporated by reference in their entirety to the extent they are not inconsistent with the teachings of the specification.

### SUMMARY OF THE INVENTION

The invention involves a manually-openable, pressure responsive, opening means applied to a sleeve-like bag that closes upon its release to prevent the contents of the bag from spilling. The device has opposing strips joined at the ends that are placed in or around the throat of the bag opening. Squeezing the ends toward one another causes the strips of the device to part opening the throat of the bag. Upon release of the ends, the strips snap back together obstructing the opening in the throat of the bag and preventing the contents of the bag from spilling.

### BRIEF DESCRIPTION OF THE DRAWINGS

FIG. 1 is an exploded perspective view of a preferred embodiment of the opening means of the subject invention formed by extrusion.

FIG. 2 is an exploded side elevational view of the embodiment shown in FIG. 1.

FIG. 3 is a perspective view of the embodiment shown in FIG. 1 closed and latched.

FIG. 4 is a side elevational view of the embodiment shown in FIG. 1 closed and latched.

FIG. 5 is a perspective view of another preferred embodiment of the opening means of the subject invention formed by extrusion.

FIG. 6 is a side elevational view of the embodiment shown in FIG. 5.

FIG. 7 is a perspective view of another preferred embodiment of the opening means of the subject invention formed by injection molding.

FIG. 8 is a perspective view of the embodiment shown in FIG. 7 folded.

FIG. 9 is a side elevational view of the embodiment shown in FIG. 7 closed and latched.

FIG. 10 is the other side elevational view of the embodiment shown in FIG. 7 closed and latched.

FIG. 11 is an exploded perspective view of another preferred embodiment of the opening means of the subject invention suitable for application to the outside of a bag.

FIG. 12 is an exploded side elevational view of the embodiment shown in FIG. 11.

FIG. 13 is a perspective view of another preferred embodiment of the opening means of the subject invention.

FIG. 14 is a broadside elevational view of the embodiment shown in FIG. 13.

FIG. 15 is a side edge elevational view of the embodiment shown in FIG. 13.

FIG. 16 is an end view of the embodiment shown in FIG. 13.

FIG. 17 is a side elevational view of a preferred embodiment of the subject invention positioned around the throat of a flexible pouch.

FIG. 18 is a side elevational view of a preferred embodiment of the subject invention positioned inside the throat of a flexible pouch.

### DETAILED DESCRIPTION OF THE INVENTION

The invention involves a device applied to a flexible sleeve-like bag that opens with one hand and closes the bag automatically to prevent the contents of the bag from spilling.

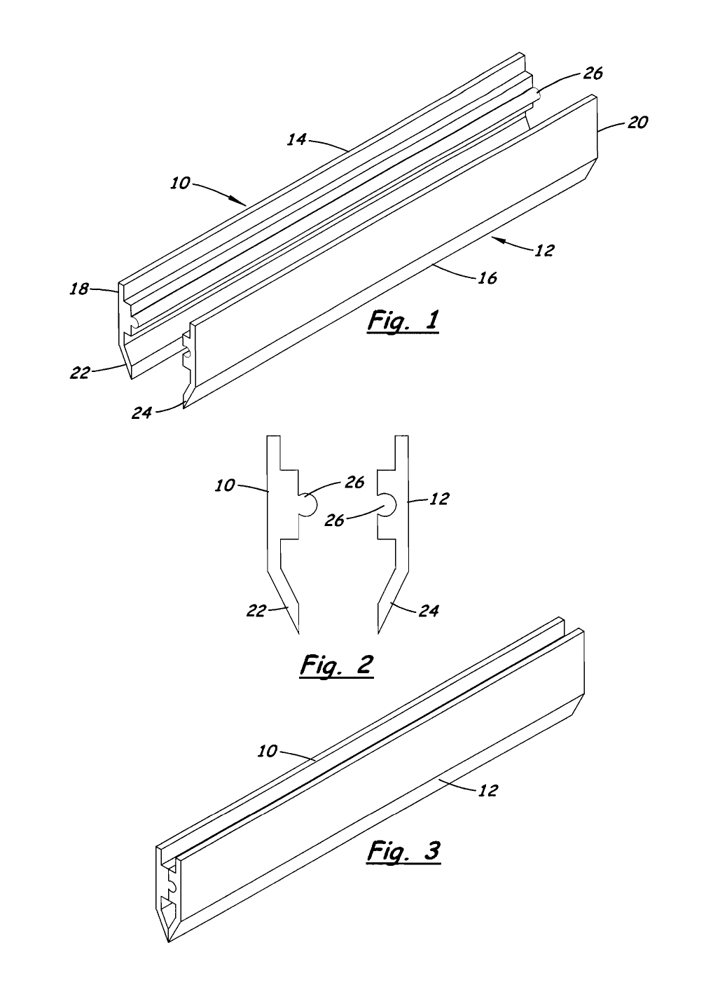

A preferred embodiment of the device of the subject invention is shown in FIG. 1. The device is a manually openable, pressure responsive, opening means. The opening means has opposing strips. The strips are connected to one another at each end. The ends can be connected by a latch system or can be adhered to one another. Pressure on the ends of the strips, pushing one end toward the other, causes the strips to part and form an opening. Upon release of the pressure, the strips snap back contacting one another again to close the opening. The subject device is placed in or around the throat of a flexible pouch.

In the embodiment shown in FIG. 1, the strips 10, 12 have an elongated body with two elongated edges 14, 16 and two ends 18, 20. Flanges on the strips assist the device in returning to its original position, closed. The flanges 22, 24, extend from an edge of the strip 14, 16, respectively, and proceed at an angle of from about 20 degrees to about 35 degrees. In a preferred embodiment the flange extends from the edge of the strip at about 25 degrees and is about one-half the width of the strip.

The strips can be made of a variety of materials, or mixtures of materials, that provide the flexible memory necessary to return the strips to the original shape. In the exemplified embodiments, the strips are formed of plastic by injection molding and extrusion. It should be noted however that the strips can be made of other materials and by other means as long as the materials have a flexible memory.

The subject device can comprise a latch securement member 26. The securement member allows the bag to be temporarily sealed for storage. In the exemplified embodiment, a simple ball latch is used to secure one strip to the other. It should be noted however that any suitable securing means can be applied to the subject strips to secure the strips together (see, for example, U.S. Pat. No. 7,204,388 B2). Additionally, latch securement means 26 can be present on the bags as integral members of the subject opening means, as shown, or independent of those means.

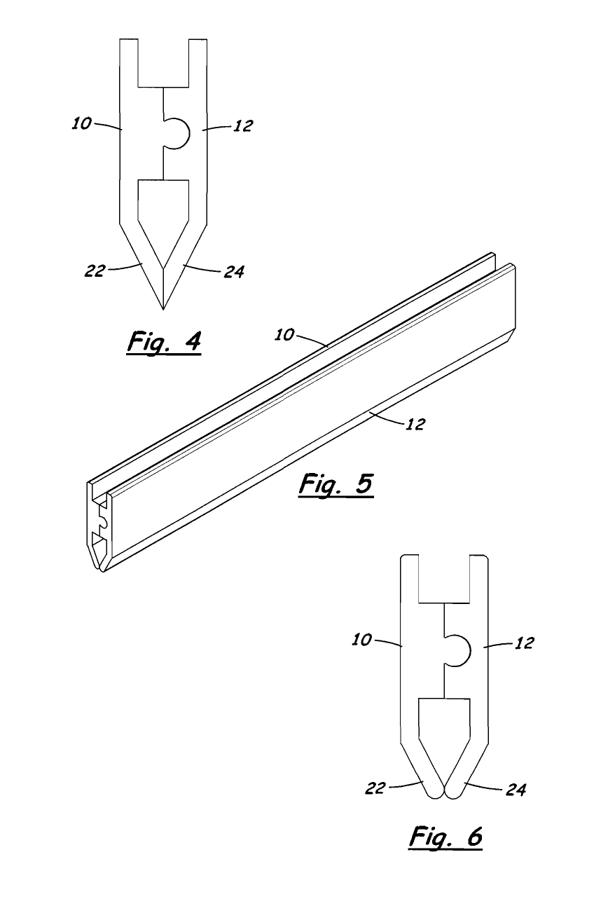

As noted previously, in the exemplified embodiments, the device of the subject invention are plastic. FIGS. 1-6 show embodiments of the device made of plastic and formed by extrusion. Each strip 10, 12 with its flange 22, 24, and any other associated devices such as securement means 26 or liquid barrier means, is extruded in a continuous roll. Individual strips are cut to length from the roll. Opposing strips are joined at the ends and then adhered to the throat of the sleeve-like flexible bag near its opening by appropriate means. These means can include, but are not limited to, heat, sonic welding, glues and adhesives. All embodiments of the opening means of the subject invention can be applied within the throat of the bag or around the outside of the bag.

FIGS. 5 and 6 show a particularly preferred embodiment of an extruded version of the subject invention. In this embodiment, strip and flange edges are rounded. Rounded edges on these components are preferred for assembly and machining processes.

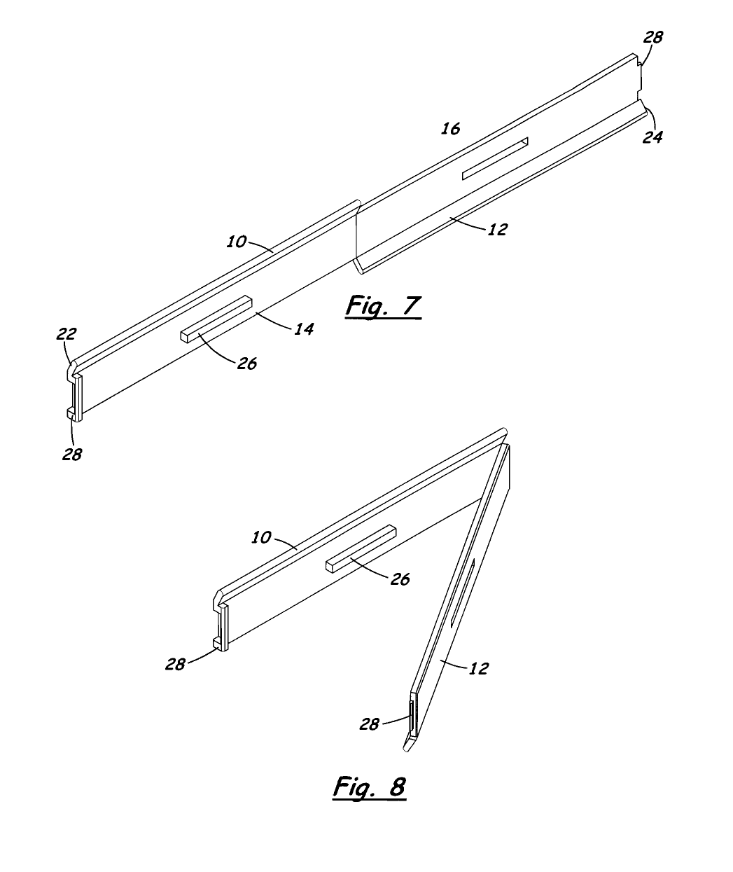

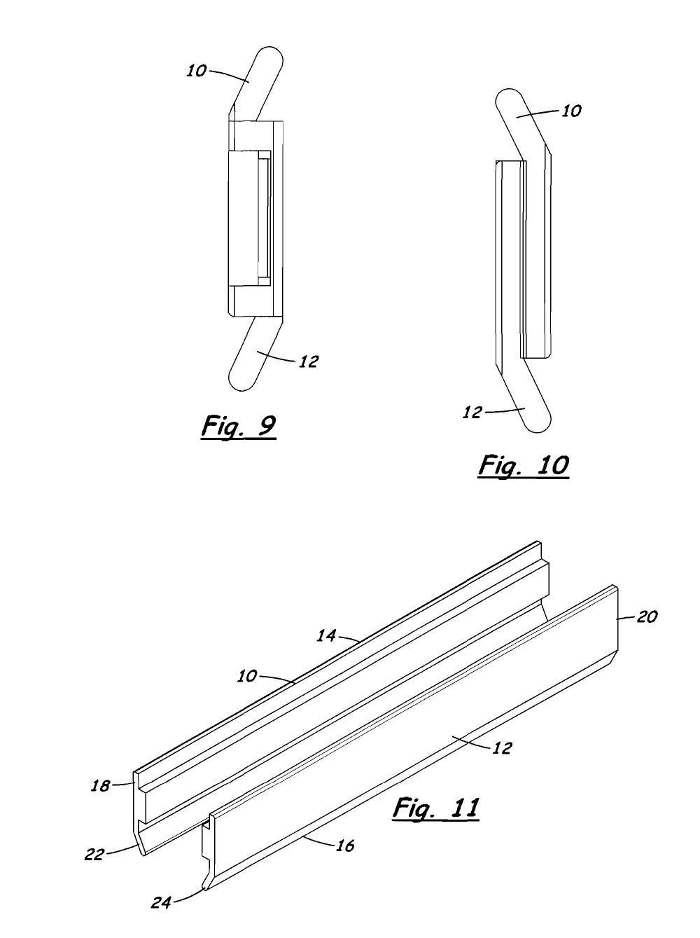

Another preferred embodiment of the device of the subject invention is shown in FIGS. 7-10. In this embodiment, both strips 10, 12 are formed in a single mold and are folded to oppose one another. Latch pieces 28 molded into the free ends of each strip secure the other end of the strips together. In the exemplified embodiment, the flange of one strip 22 extends from the top of the strip while the flange of the other strip 24 extends from the bottom of the strip. As shown in FIGS. 9 and 10 this is done to reduce the stack height on the assembled strip.

FIGS. 11 and 12 show an alternate embodiment of the subject invention. This embodiment, does not include a latch securement means. The opening means remains pressure, squeeze openable and returns to a closed position upon release of pressure to close the bag. Flanges on each strip assist in snapping the bag closed. The subject embodiment, can be applied within the throat of a sleeve-like bag or around the outside of the bag.

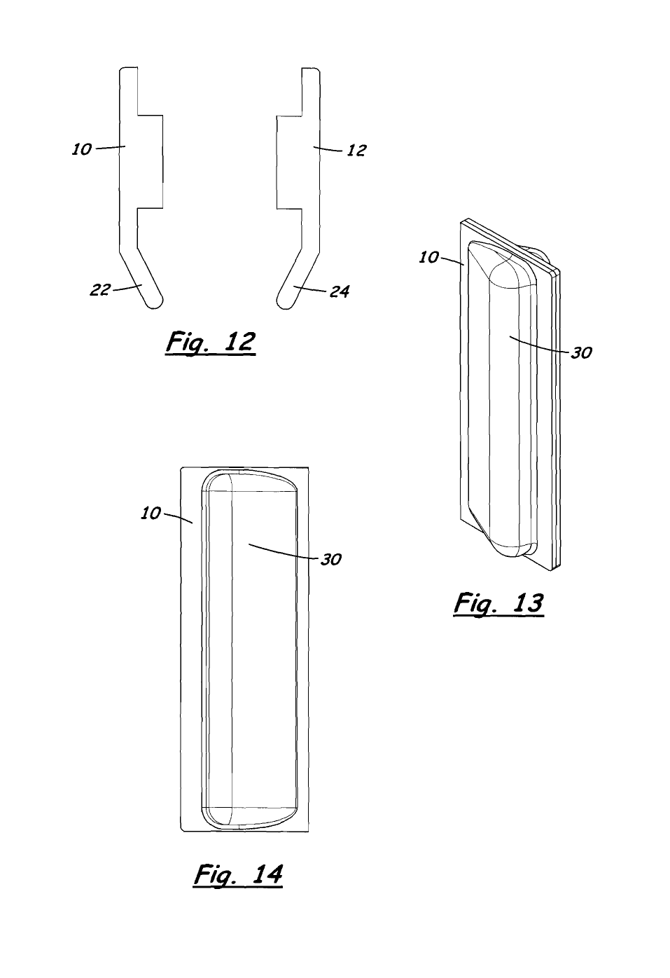

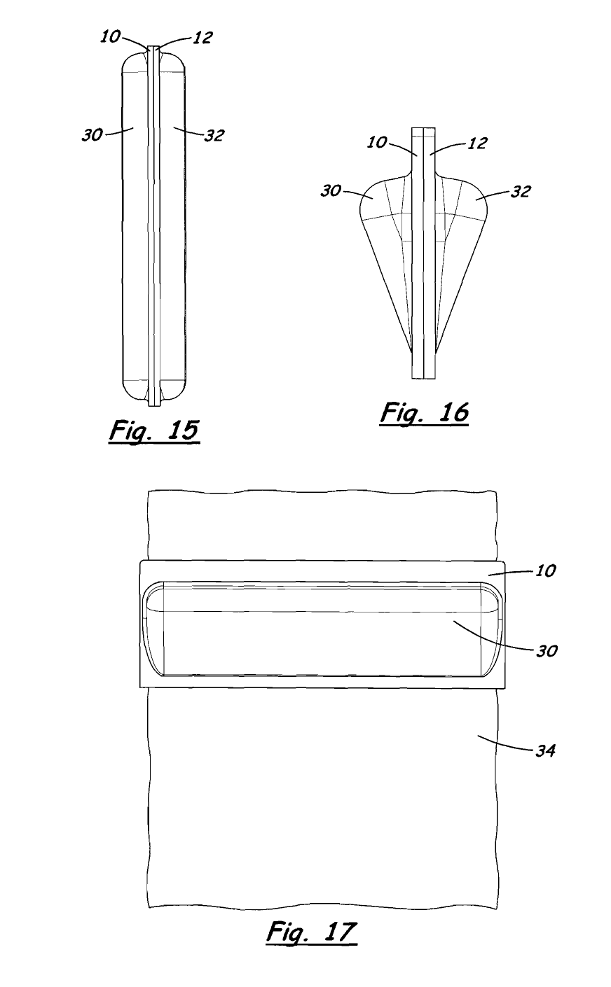

FIGS. 13-16 show another preferred embodiment of the device of the subject invention. In this embodiment, a bulge in the center of each strip 10, 12 cause the strips to return to their original position, closed. The bulge in each strip 30, 32, like the flange, provide a structural biasing means to return the strips to their original position. In It should be apparent to one skilled in the art however there are other structural means that can be used to cause the strips to snap closed. In this embodiment, the bulge has a half teardrop shape. The exemplified shape provides the strip tensile strength and is easy to form by injection molding. Other bulge shapes however can be applied to the strips to give them their resilient properties.

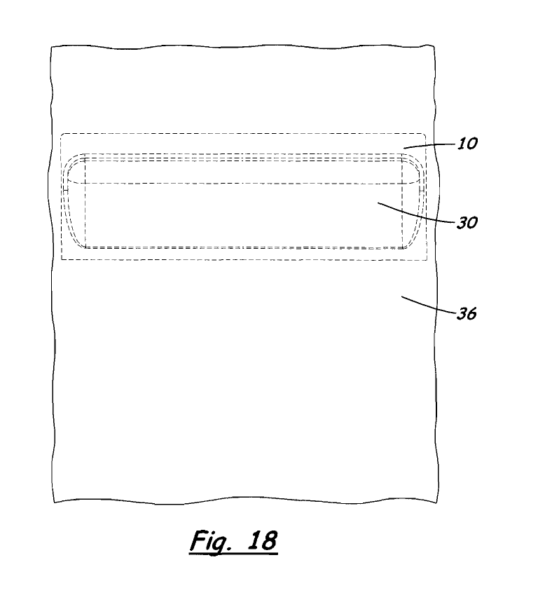

In a particularly preferred embodiment, the bulge is centered on the strip surround by a planar border that when in contact with the planar border of the opposing strip provides a sealing surface. The planar border also provides structure to the strip. This planar area need not surround the bulge but can be just a margin on one side of the bulge. Further, no border or margin is necessary. The shape and structure of the opposing strips need only assure that an opening if formed when the ends of the strips are squeezed and that opening closes upon release of pressure on the ends. Strip shapes and structures suitable for the subject invention can include, but are not limited to, oval, semi-circular and triangular. The exemplified embodiment can be positioned outside the bag 34 and around the throat of the bag (FIG. 17) or inside the throat of the bag 36 (FIG. 18). If positioned inside the throat of the bag, the sealing surface can include securement means 26.

The subject device is a pressure responsive squeeze openable means that upon release of the pressure snaps back to close the opening created. Applying this device to flexible packaging bags makes them spill-proof The opening means is squeezed to open the bag and access its contents then upon release the bag snaps closed to prevent the contents from spilling. The subject device is particularly useful when applied to single serving packages of snack foods. It should be noted that the subject embodiment can be used in association with other devices found on such packages, like, for example, zipper-type securement means, liquid barrier means, and tamper/open indicating means.

It is understood that the foregoing examples are merely illustrative of the present invention. Certain modifications of the articles and/or methods may be made and still achieve the objectives of the invention. Such modifications are contemplated as within the scope of the claimed invention.

1. A self-closing, squeeze-openable device for a flexible pouch comprising:
a strip having an elongated body, opposing elongated edges, and one end and an opposite end;
another strip having an elongated body, opposing elongated edges, and one end and an opposite end, the one end of the strip connected to the one end of the another strip and the opposite end of the strip connected to the opposite end of the another strip to form opposing strips; and
biasing means to bias the strip to the another strip, wherein the biasing means comprises a bulge which extends along the elongated body of the strip between the opposing elongated edges, and another bulge which extends along the elongated body of the another strip between the opposing elongated edges;
wherein when squeezing pressure is applied to the connected one ends of the opposing strips pushing the connected one ends toward the connected opposite ends of the opposing strips an opening is formed and when the pressure is released the opening closes.

2. The device of claim 1, wherein said biasing means further comprises a planar border between said bulge and said opposing elongated edges on said strip, and a planar border between said bulge and said opposing elongated edges on said another strip.

3. The device of claim 1, wherein said ends of said opposing strips are connected by fusion.

4. The device of claim 1, wherein said device is positioned in a throat of said flexible pouch.

5. The device of claim 1, wherein said device is positioned around a throat of said flexible pouch.

6. The device of claim 1, further comprising securement means.

7. The device of claim 6, wherein said securement means is a ball latch.

8. A method of making a self-closing, squeeze-openable device for a flexible pouch, the method comprising the steps of:
creating a strip having an elongated body, opposing elongated edges, and one end and an opposite end;
creating another strip having an elongated body, opposing elongated edges, and one end and an opposite end;
connecting the one end of the strip to one end of the another strip;
connecting the opposite end of the strip to the opposite end of the another strip to form opposing strips; and
providing biasing means to bias the strip to the another strip, wherein the biasing means comprises a bulge which extends along the elongated body of the strip between the opposing elongated edges, and another bulge which extends along the elongated body of the another strip between the opposing elongated edges;
wherein when squeezing pressure is applied to the connected one ends of the opposing strips pushing the connected one ends toward the connected opposite ends of the opposing strips an opening is formed and when the pressure is released the opening closes.

9. The method of claim 8, wherein said strip and said another strip are created by extrusion.

10. The method of claim 8, wherein said strip and said another strip are created by injection molding.

11. A self-closing, squeeze-openable flexible pouch comprising:
an opening means comprising a strip having an elongated body, opposing elongated edges, and one end and an opposite end, and another strip having an elongated body, opposing elongated edges, and one end and an opposite end, the one end of the strip connected to the one end of the another strip and the opposite end of the strip connected to the opposite end of the another strip to form opposing strips; and
biasing means to bias the strip to the another strip, wherein the biasing means comprises a bulge which extends along the elongated body of the strip between the opposing elongated edges, and another bulge which extends along the elongated body of the another strip between the opposing elongated edges;
wherein when squeezing pressure is applied to the connected one ends of the opposing strips pushing the connected one ends toward the connected opposite ends of the opposing strips an opening is formed and when the pressure is released the opening closes.

12. The pouch of claim 11, wherein said opening means is positioned in a throat of said flexible pouch.

13. The pouch of claim 11, wherein said opening means is positioned around a throat of said flexible pouch.

14. The pouch of claim 11, wherein said biasing means further comprises a planar border between said bulge and said opposing elongated edges on said strip, and a planar border between said bulge and said opposing elongated edges on said another strip.

15. The pouch of claim 11, wherein said ends of said opposing strips are connected by fusion.

16. The pouch of claim 11, further comprising securement means.
